(19) United States
(12) Patent Application Publication
(10) Pub. No.: US 2024/0223250 A1
(43) Pub. Date: Jul. 4, 2024

(54) MULTI-AP CHANNEL SOUNDING FEEDBACK PROCEDURES FOR WLAN SYSTEMS

(71) Applicant: INTERDIGITAL PATENT HOLDINGS, INC., Wilmington, DE (US)

(72) Inventors: Mahmoud Saad, Montreal (CA); Hanqing Lou, Syosset, NY (US); Xiaofei Wang, North Caldwell, NJ (US); Zinan Lin, Basking Ridge, NJ (US); Rui Yang, Greenlawn, NY (US)

(73) Assignee: INTERDIGITAL PATENT HOLDINGS, INC., Wilmington, DE (US)

(21) Appl. No.: 18/556,787

(22) PCT Filed: Apr. 22, 2022
(86) PCT No.: PCT/US2022/025931

§ 371 Date: Oct. 23, 2023

Related U.S. Application Data
(60) Provisional application No. 63/178,936, filed on Apr. 23, 2021.
(60) Provisional application No. 63/191,651, filed on May 21, 2021.

(51) Int. Cl. H04B 7/06

(52) U.S. Cl. CPC H04B 7/0617; H04B 7/0626; H04B 7/0632

(57) ABSTRACT

A station (STA) that is associated with a first access point (AP), that is a member of a multi-AP set receives a trigger frame from a second AP that is also a member of the multi-AP set. The STA is not associated with the second AP. The trigger frame includes an association identifier (AID) relating to the association between the STA and the first AP, and an AP identifier (APID) of the first AP. The STA transmits a feedback message, to the second AP, including information indicative of a channel quality of a communication channel between the STA and the second AP. Various formats for a trigger frame to solicit feedback from an OBSS STA, are disclosed.

### CROSS-REFERENCE TO RELATED APPLICATIONS

This application claims the benefit of U.S. Provisional Application No. 63/178,936, filed Apr. 23, 2021, and U.S. Provisional Application No. 63/191,651, filed May 21, 2021, the contents of which are incorporated herein by reference.

### BACKGROUND

A Wireless Local Area Network (WLAN) in an Infrastructure Basic Service Set (BSS) mode may include an Access Point (AP) for the BSS and one or more stations (STAs) associated with the AP. The AP may have access or interface with a Distribution System (DS) or another type of wired/wireless network that carries traffic in and out of the BSS. Traffic to STAs that originates from outside the BSS arrives through the AP may be delivered to the STAs. Traffic originating from STAs to destinations outside the BSS may be sent to the AP to be delivered to the respective destinations. Traffic between STAs within the BSS may also be sent through the AP where the source STA sends traffic to the AP and the AP delivers the traffic to the destination STA.

In accordance with the Institute of Electronics and Electrical Engineers (IEEE) 802.11 standards for infrastructure mode of operation, such as 802.11ac and/or 802.11ax, an AP may transmit a beacon on a fixed channel, usually the primary channel. This channel may be 20 MHz wide, and may be the operating channel of the BSS. This channel may also be used by the STAs to establish a connection with the AP. The fundamental channel access mechanism in an 802.11 system may be Carrier Sense Multiple Access with Collision Avoidance (CSMA/CA). In this mode of operation, some STAs, or every STA, including the AP, may sense the primary channel. If the channel is detected to be busy, the STA may back off. Hence, one STA may transmit at any given time in a BSS.

In embodiments operating according to 802.11n standards, High Throughput (HT) STAs may also use a 40 MHz wide channel for communication. This may be achieved by combining the primary 20 MHZ channel, with an adjacent 20 MHz channel to form a 40 MHz wide contiguous channel.

In embodiments operating according to 802.11ac standards, Very High Throughput (VHT) STAs may support 20 MHz, 40 MHZ, 80 MHZ, and/or 160 MHz wide channels. The 40 MHz and 80 MHZ, channels may be formed by combining contiguous 20 MHz channels similar to 802.11n described above. A160 MHZ channel may be formed either by combining 8 contiguous 20 MHz channels, or by combining two non-contiguous 80 MHz channels, which may also be referred to as an 80+80 configuration. For the 80+80 configuration, the data, after channel encoding, may be passed through a segment parser that divides it into two streams. The Inverse Discrete Fourier Transformation (IDFT) operation and time domain processing may be done on each stream separately. The streams may then mapped be on to the two channels, and the data may be transmitted. At the receiver, this mechanism may be reversed, and the combined data may be sent to the MAC.

To improve spectral efficiency, systems operating in accordance with 802.11ac standards may implement the concept of downlink Multi-User MIMO (MU-MIMO) transmissions from an AP to multiple STAs in the same symbol's time frame, e.g. during a downlink OFDM symbol. The potential for the use of downlink MU-MIMO may also be considered for embodiments operating in accordance with 802.11ah standards. It is important to note that since downlink MU-MIMO, as it is used in 802.11ac, may use the same symbol timing for transmissions to multiple STAs, interference of the waveform transmissions to multiple STA's may not be an issue. However, all STA's involved in MU-MIMO transmission from the AP may need to use the same channel or band, and this may limit the operating bandwidth to the smallest channel bandwidth that is supported by the STAs that are included as destinations of the MU-MIMO transmission from the AP.

### SUMMARY

A station (STA) that is associated with a first access point (AP), that is a member of a multi-AP set receives a trigger frame from a second AP that is also a member of the multi-AP set. The STA is not associated with the second AP. The trigger frame includes an association identifier (AID) relating to the association between the STA and the first AP, and an AP identifier (APID) of the first AP, The STA transmits a feedback message, to the second AP, including information indicative of a channel quality of a communication channel between the STA and the second AP. Various formats for a trigger frame to solicit feedback from an OBSS STA, are disclosed.

In one embodiment, the trigger frame is a beamforming report poll (BFRP) trigger frame. The BFRP trigger frame includes a User Info field that includes the AID relating to the association between the STA and the first AP. The User Info field also includes a Trigger Dependent User Info field that includes an overlapping basic service set (OBSS) indicator and the APID of the first AP. The OBSS indicator indicates that the APID is an overlapping basic service set (OBSS) AP.

In another embodiment, the trigger frame is a BFRP trigger frame, and the BFRP trigger frame includes a New Special User Info field as well as at least one User Info field. The New Special User Info field includes a User Pointer field associated with a corresponding User Info field. The User Pointer field includes the APID, and the corresponding User Info field includes the AID relating to the association between the STA and the first AP

In the disclosed embodiments, an OBSS STA (i.e. an unassociated STA) receiving the BFRP trigger frame may be unambiguously identified using the AID and the APID. The OBSS STA can then transmit feedback to the unassociated AP.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates examples of sequential channel sounding procedures and joint channel sounding procedures performed in a multi-AP system;

FIG. 3 illustrates an example of a High Efficiency (HE) Null Data Packet (NDP) Announcement frame format;

FIG. 4 illustrates an example of a STA Info field format in an EHT NDP Announcement frame;

FIG. 5 illustrates an example of a Trigger frame format;

FIG. 6 illustrates an example of an Extremely High Throughput (EHT) Variant User Info field format;

FIG. 7 illustrates an example of an: EHT Special User Info field format;

FIG. 8 shows one exemplary procedure for collecting Channel State Information (CSI) feedback from Overlapping BSS (OBSS) STAs;

FIG. 9 shows another exemplary procedure for collecting CSI feedback from OBSS STAs;

FIG. 10 provides an example of an EHT/Enhanced Compressed Beamforming/Channel Quality Information (CQI) frame Action field format;

FIG. 11 illustrates an example of the Trigger Dependent User Info subfield;

FIG. 12 illustrates an example of a new Special User Info that may be included in a Trigger frame;

FIG. 13 illustrates an example of a modified EHT/Enhanced Multiple Input-Multiple Output (MIMO) Control Field; and

FIG. 14 illustrates two embodiments for soliciting OBSS STA feedback using a Trigger frame.

### DETAILED DESCRIPTION

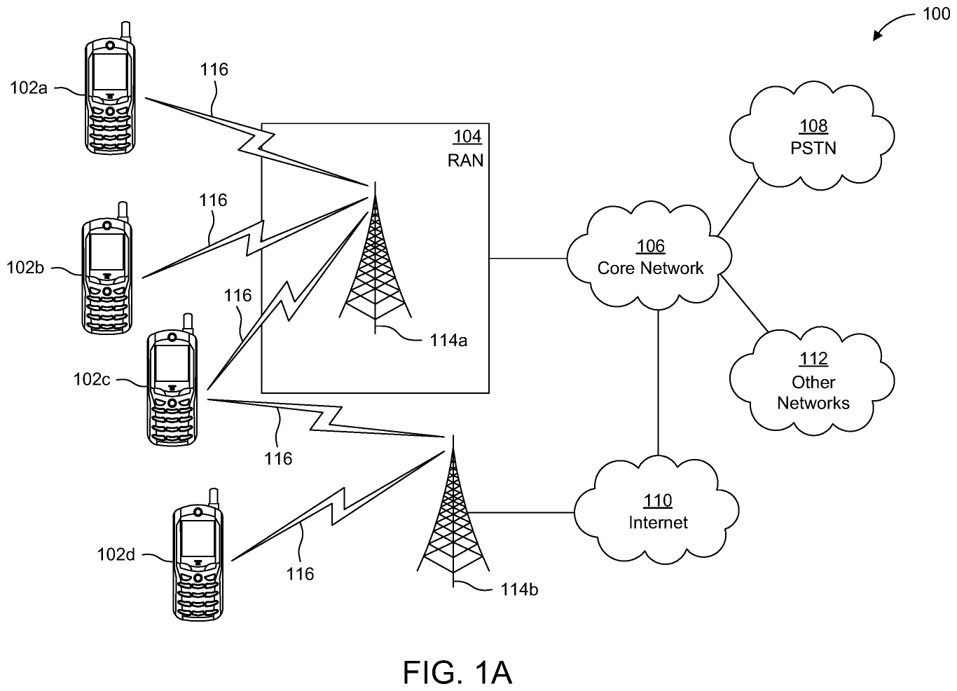

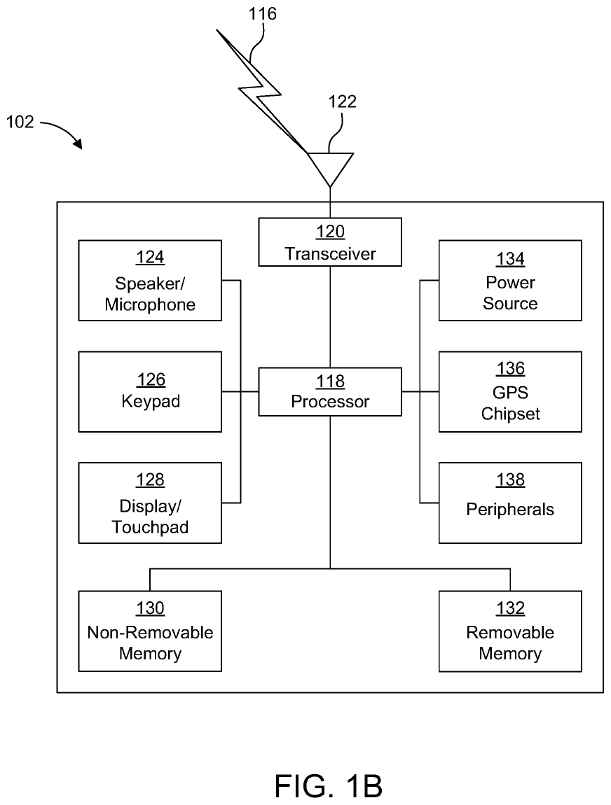

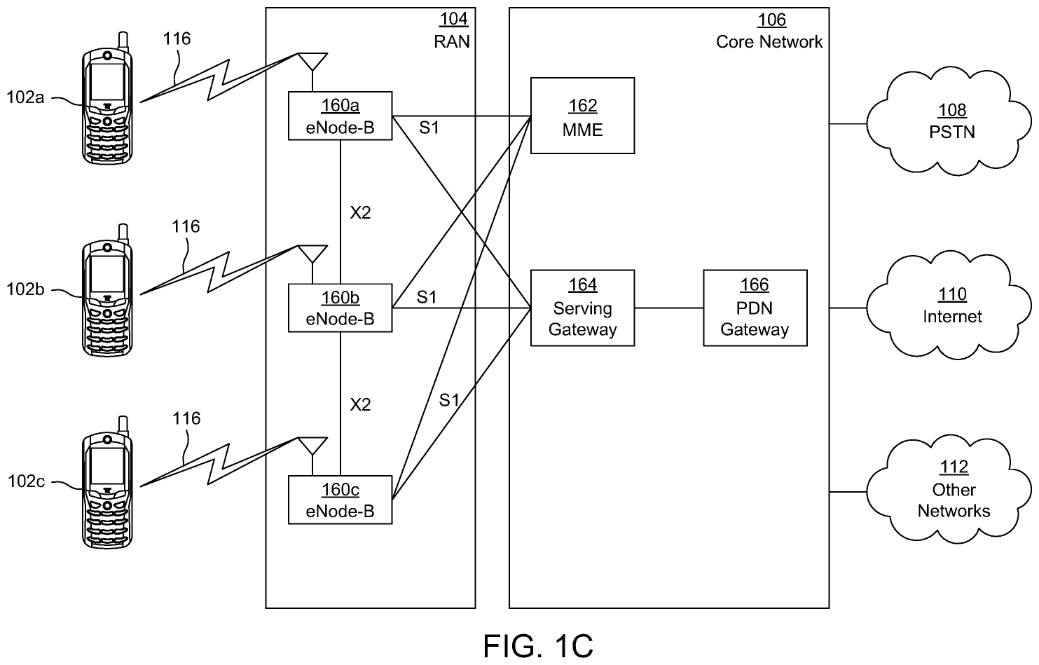

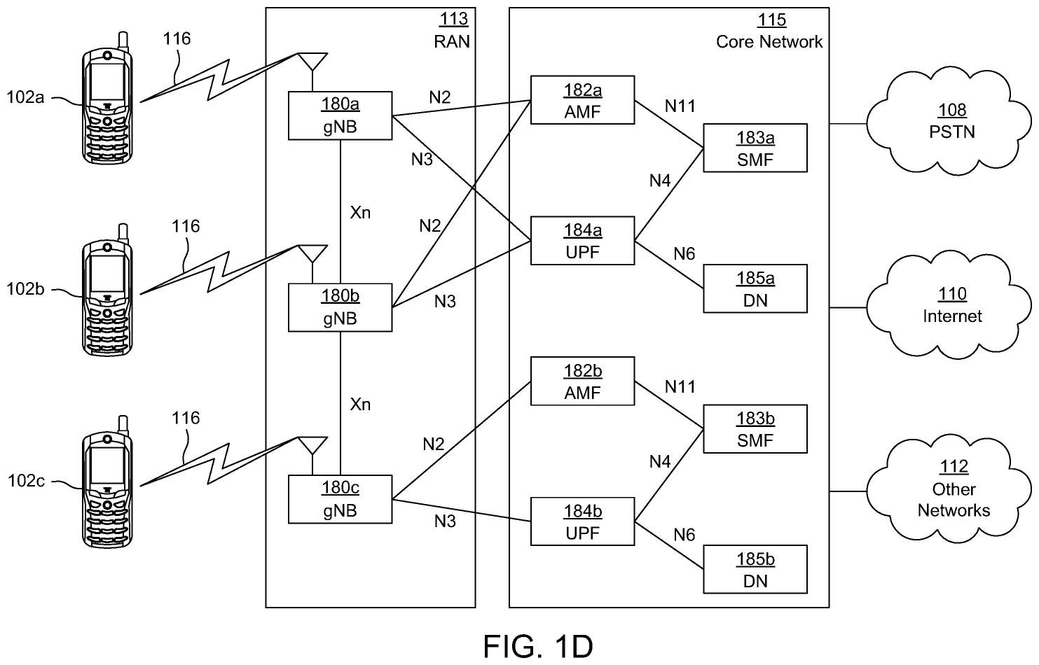

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The IEEE 802.11 Extremely High Throughput (EHT) Study Group was formed in September 2018. EHT developments may provide one basis for the next major revision to IEEE 802.11 standards following 802.11ax. The EHT study group explores the possibility to further increase peak throughput and improve efficiency of IEEE 802.11 networks. Following the establishment of the EHT Study Group, the 802.11be Task Group was also established to provide 802.11 EHT specifications. Use cases and applications addressed include high throughput and low latency applications, such as: Video-over-WLAN; Augmented Reality (AR); and Virtual Reality (VR). A list of features that has been discussed in the EHT SG and 802.11be to achieve the target of increased peak throughput and improved efficiency includes: multi-AP; multi-Band/multi-link; 320 MHz bandwidth; 16 Spatial Streams; HARQ; AP Coordination; and new designs for 6 GHz channel access. The IEEE Standard board approved the IEEE 802.11be Task Group (TG) based on a Project Authorization Request (PAR) and Criteria for Standards Development (CSD) developed by the EHT study group.

Further details relating to multi-AP transmissions in accordance with 802.11be standards are described herein. Basically, multi-AP operation includes a STA receiving a transmission from multiple APs. The multi-AP transmission may be an MU transmission such that multiple transmissions are received from each AP at a same time.

Coordinated multi-AP (C-MAP) transmissions may be supported in 802.11be. Such C-MAP transmission schemes may include: Coordinated Multi-AP OFDMA; Coordinated Multi-AP TDMA; Coordinated Multi-AP Spatial Reuse; Coordinated beamforming/nulling; and Joint Transmission.

In the context of coordinated multi-AP systems, several terms are defined and used herein. For example, a sharing AP may refer to an EHT AP or a set of EHT APs that obtains a transmission opportunity (TXOP) and initiates multi-AP coordination. The sharing AP is also referred to as the coordinating AP. A shared AP refers to an EHT AP or a set of EHT APs that are coordinated for multi-AP transmission by the sharing AP. An AP candidate set refers to an AP or a set of APs that initiate or participate in multi-AP coordination.

802.11be standards may support mechanisms to determine whether an AP is part of an AP candidate set and can participate as a shared AP in coordinated multi-AP transmission initiated by a sharing AP. Procedures may need to be defined for an AP to share its frequency/time resources of an obtained TXOP with a set of APs. An AP that intends to use the resource (i.e., frequency or time) shared by another AP may be able to indicate its resource needs to the AP that shared the resource. Coordinated OFDMA may be supported in 11be, and in a coordinated OFDMA, both DL OFDMA and its corresponding UL OFDMA acknowledgement may be allowed.

Further details relating to multi-AP channel sounding in accordance with 802.11be standards are described herein. Channel sounding in accordance with 802.11n and 802.11ac standards may be performed using two different schemes, generally termed explicit channel sounding or implicit channel sounding. In explicit channel sounding, the AP may transmit an NDP to the STA with a preamble that allows the STA to measure its own channel and send CSI feedback to the AP. In implicit channel sounding, the STA may send an NDP, and the AP may measure the channel of the STA assuming that the channel is reciprocal.

802.11be may support a maximum number (for example, 16) of spatial streams for SU-MIMO and for MU-MIMO. The maximum number of spatial streams allocated to each MU-MIMO scheduled non-AP STA may be limited, e.g., to 4. The maximum number of users for which DL transmissions may be spatially multiplexed may be, e.g., 8 per RU.

802.11be may support two or more modes of channel sounding in multiple-AP systems. Two of these modes of channel sounding may be sequential sounding and joint sounding. In sequential sounding, each AP may transmit an NDP independently without an overlapped sounding period of each AP. In other words, each AP performs sounding in its own time period, and these sounding time periods may then be called sequential. In joint sounding, where an AP has less than or equal to a total of 8 antennas active on all LTF tones and uses 802.11ax P-matrix across OFDM symbols. In other words, joint sounding in a multiple-AP system includes an AP having 8 or fewer antennas may have all antennas active on all LTF tones and use an 802.11ax P-matrix to send/receive sounding signals.

CSI feedback collection may be performed using an 802.11ax-like four-step sounding sequence ((Null Data Packet Announcement (NDPA)+NDP+Beamforming Report Poll (BFRP) Trigger frame+CSI report) in a multiple-AP system to collect the feedback from both in-BSS and overlapping BSS (OBSS) STAs. In other words, this four-step process may be used to obtain sounding feedback from STAs in a BSS operated by an AP, and STAs in an overlapping BSS that are not associated with that same AP. In sequential sounding for multiple-AP systems, a STA may process an NDPA frame and the BFRP Trigger frame received from an OBSS AP, and the STA may respond with corresponding CSI to the OBSS AP, if polled with a BFRP TF from the OBSS AP.

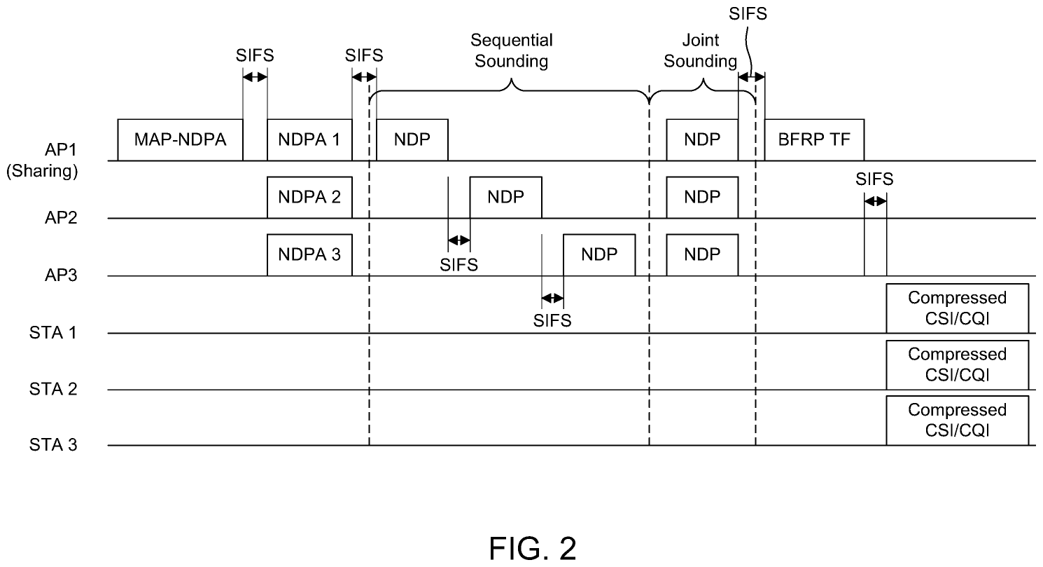

FIG. 2 illustrates a signal flow diagram showing examples of both a sequential channel sounding procedure and a joint channel sounding procedure performed in a multi-AP system. To start either process, in one example, the sharing AP (AP1) transmits a multi-AP NDPA, then each AP in the coordinating group (AP1, AP2, and AP3) may transmit an NDPA. In the sequential sounding scheme, each AP in the coordinating group (AP1, AP2, and AP3) may transmit an NDP in a different non-overlapped time to all the STAs in the coordinating group (i.e. time-multiplexed). In this scenario, each NDP may be separated by a short interframe space (SIFS) time interval. In a joint sounding scheme, the coordinated APs (AP1, AP2, and AP3) may each transmit an NDP simultaneously where different Long Training Field (LTF) tones are either spanning the entire bandwidth and multiplexed spatially or using orthogonal codes. Otherwise, each AP may transmit their respective LTF tones only on selected tones such that there is no overlap in tones amongst the APs. STAs that receive the NDP frames (STA1, STA2, and STA3) may then determine CSI or CQI and transmit that information back to one of the APs in the coordinating group (AP1, AP2, or AP3).

When a STA (such as STA1, STA2, or STA3 shown in FIG. 2) receives an NDP, it may measure the channel and prepare a CSI feedback report. At least three different ways may be used to collect the CSI from the STAs. In some cases, each AP may collect all CSI that includes the feedback of the in-BSS and OBSS STAs. In some cases, each AP may collect CSI from its associated STAs only. And in some cases, the sharing AP (AP1 in FIG. 2) may collect the CSI for all the shared APs in the coordination group.

Various challenges exist in channel sounding procedures in multi-AP systems. One such problem is that STAs involved in the sounding procedure may be unable to hear the coordinating AP.

Other challenges may involve the synchronization of APs in the multi-AP coordinating set; overhead, complexity and performance of different sounding schemes; variants of NDP Transmission in explicit and implicit sounding; and feedback collection and reduction.

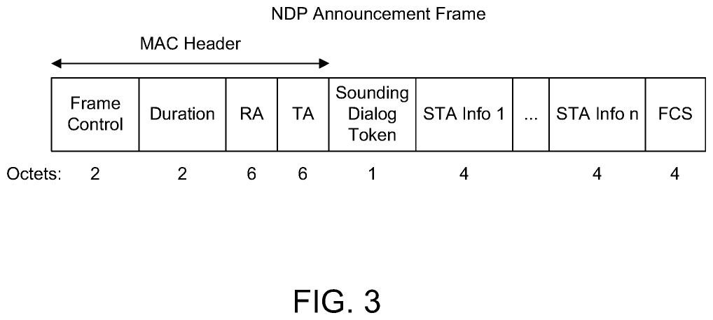

The 802.11be TG has agreed to keep the structure of the NDP Announcement (NDPA) similar to the NDPA of 802.11ax as illustrated in FIG. 3. However, the STA Info field depicted in FIG. 3 is changed to accommodate the new features of 802.11be EHT.

As mentioned, FIG. 3 illustrates an example of an HE NDP Announcement frame format consistent with 802.11ax. One skilled in the art will recognize this 802.11ax NDP Announcement frame format. The Frame includes, in the MAC header, a Frame Control field, a Duration field, a receiver address (RA) field, and a transmitter address (TA) field. A sounding dialog token is then followed by some number of STA Info fields, shown as STA Info 1 through STA Info n in FIG. 3. A frame check sequence (FCS) is the last field of the frame.

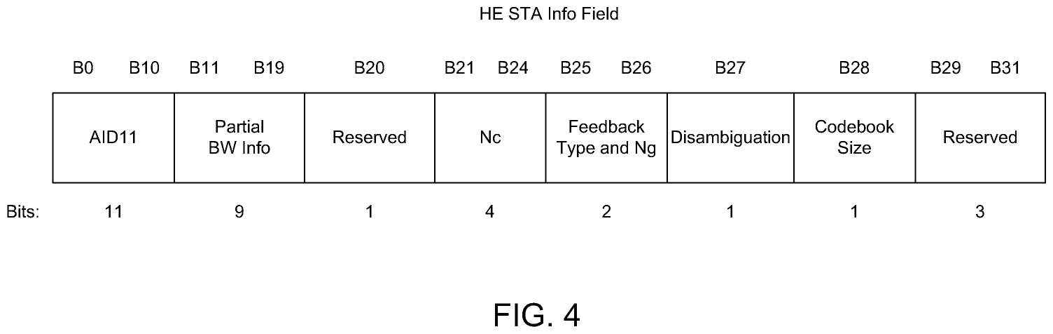

The STA Info 1 field shown in FIG. 3 is shown in greater detail in FIG. 4. FIG. 4 illustrates an example of a STA Info field format in an EHT NDP Announcement frame. The STA Info field includes an association identifier (AID) field, a Partial bandwidth (BW) Info field, a Reserved bit, a Nc field, a Feedback Type and Ng field, a Disambiguation bit, a Codebook Size bit, and a Reserved field.

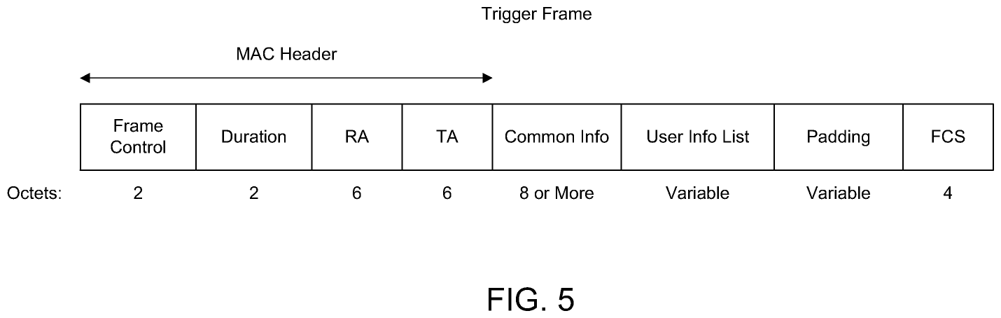

FIG. 5 illustrates an example of a trigger frame format. The Trigger frame includes a Frame Control field, a Duration field, an RA field, and a TA field in a MAC header of the Trigger frame. The Trigger frame further includes a variable length Common Info field, a variable length User Info List field, a variable length Padding field, and finally an FCS field. The Trigger frame may function to allocate resources to one or more STAs and trigger single or multi-user access in the uplink. In a manner consistent with 802.11be standards, a new variant of the User Info field may be supported, and a Special User Info field may be added after the Common Info field. Both enhancements may allow for a unified triggering scheme for both HE (802.11ax compliant) and EHT (802.11be compliant) devices.

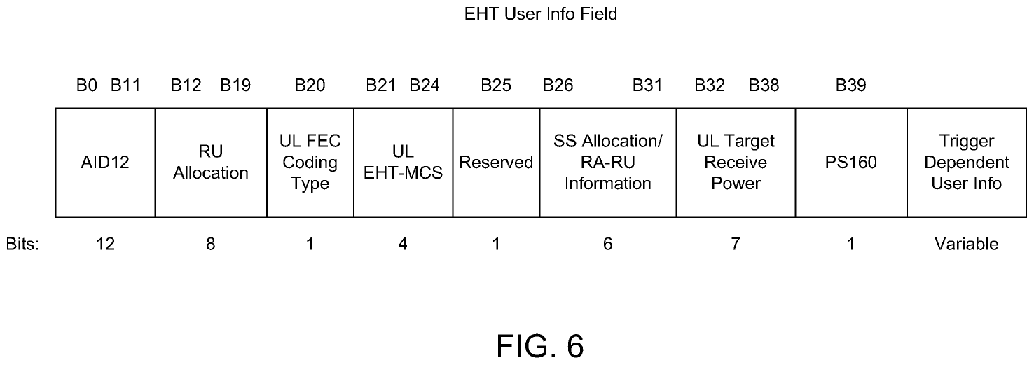

FIG. 6 illustrates an example of an EHT User Info field format. The EHT User Info Field may include an AID12 field, a resource unit (RU) allocation field, an UL FEC Coding Type field, an UL EHT-modulation and coding scheme (MCS) field, a reserved bit, a spatial stream (SS) Allocation/random access RU (RA-RU) Information field, an UL Target Receive Power field, a PS160 field, and a variable length Trigger Dependent User Info field. The content of the Trigger Dependent User Info is based on which type of trigger frame carries the EHT User Info field. For example, a beamforming feedback report poll (BFRP) trigger frame may have a Trigger Dependent User Info field that carries certain information, while a general trigger frame may have a Trigger Dependent User Info field that carries other, different information.

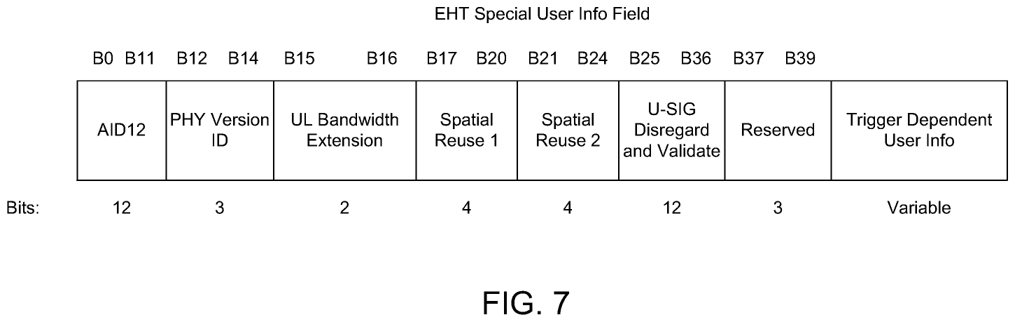

FIG. 7 illustrates an example of an EHT Special User Info field format. The EHT Special User Info field may include an AID 12 field, a physical layer (PHY Version ID field, an UL Bandwidth Extension field, a Spatial Reuse 1 field, a Spatial Reuse 2 field, a U-SI Disregard and Validate field, a Reserved field, and variable length Trigger Dependent User Info field. The content of the Trigger Dependent User Info is based on which type of trigger frame carries the EHT User Info field. For example, a beamforming feedback report poll (BFRP) trigger frame may have a Trigger Dependent User Info field that carries certain information, while a general trigger frame may have a Trigger Dependent User Info field that carries other, different information.

In 802.11be systems, a first problem exists in collecting CSI Feedback from OBSS STAs. In MAP Sounding, each AP involved in the sounding may collect CSI feedback from its associated STAs and OBSS STAs (that is, STAs associated with another AP). The feedback collection from OBSS STAs may be an open problem, especially when the OBSS STAs are at the edge of the coverage range. For example, the OBSS STA may hear the DL transmission from the coordinating AP, but the UL transmission from the STA may not reach the coordinating AP well due to insufficient transmit power and/or an insufficient number of transmit antennas.

A second problem exists in the solicitation of CSI Feedback from OBSS STAs using BFRP Trigger frames. MAP Sounding may involve the collection of CSI feedback from associated STAs and from unassociated STAs to perform coordinated transmissions (e.g., coordinated beamforming (CBF) and joint transmission (JTX)). The existing BFRP trigger frame may not support solicitation of CSI feedback from unassociated OBSS STAs. Several issues, including the indication that the BFRP trigger frame is triggering unassociated STAs from an OBSS, the identification of the unassociated OBSS STAs, and potential AID collision where several STAs from different BSSs may have the same AID, exist and must be addressed to make MAP communication possible.

A third problem exists in the optimization of channel sounding feedback procedures. A beamformer and beamformee may experience different interference levels on different subchannels. The problem may be more severe when preamble puncturing is allowed in most of the transmissions. For example, an AP may acquire a 320 MHz channel and request a STA to feedback its CSI/CQI on the 320 MHz channel. At the STA side, one or more subchannels may experience heavier interference than the rest. The STA may be unable to obtain good channel measurements on the heavily interfered subchannels. Therefore, the CSI/CQI feedback on the impacted subchannels may be unusable, or misleading.

Another problem that exists is controlling the behavior of STAs designed for different standard releases. In the Signal (SIG) field defined in the IEEE 802.11 standard, some bits may be reserved without specific values for future releases. However, without specific values in the current release (say R1) could create at least two problems when the future release (say R2) devices are available. One problem is the unpredictable behavior of R2-feature-capable devices which operate in a BSS that supports R1 features only. Another problem is the ability to disable all R2 related features for R2-feature-capable devices (not just a subset of R2 feature(s)) when it is needed.

Various solutions will now be described that address some of the above stated problems using the EHT User Info field and/or the EHT Special User Info field described above. Some embodiments may provide for methods to collect CSI feedback from OBSS STAs and may at least address the issues discussed in the first problem introduced above.

In a MAP scenario, all of the STAs may not be able to hear all of the participating APs. Alternatively, or additionally, STAs may hear the DL transmission from one or more participating APs, but the UL transmission from one or more STAs may not reach one or more participating APs. Device-to-device (D2D) transmission between STAs may help to relay the information to the APs.

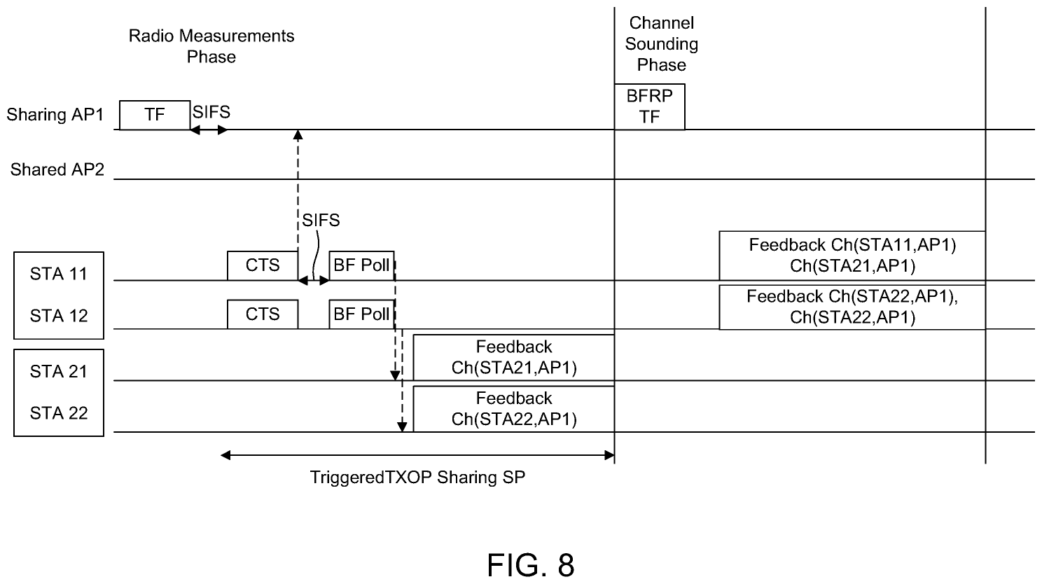

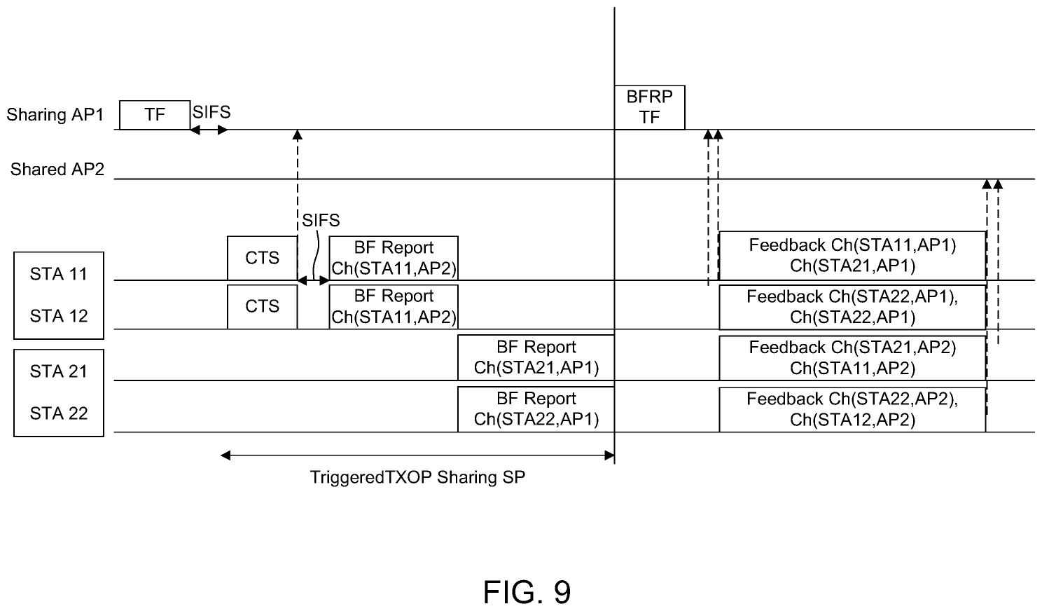

FIG. 8 Error! Reference source not found. and Error! Reference source not found. FIG. 9 show exemplary procedures for collecting CSI feedback from OBSS STAs. As shown in FIG. 8, a sharing AP1 transmits a Trigger frame to associated STAs STA11 and STA12. Note that the first numeral in the name of STA11 and STA12 indicates that the STA is associating with AP1. Similarly, STA21 and STA22 are associated with AP2, and are considered OBSS STAs with respect to sharing AP1. AP1 and AP2 form a MAP group (or MAP coordinated set) and AP1 is the sharing AP and AP2 is the shared AP. NDPA/NDP sounding exchanges may be performed and the procedures may focus on collecting the CSI/CQI feedback.

With continued reference to FIG. 8, the sharing AP, AP1, may try to acquire channel state information (CSI) between itself and OBSS STAs or unassociated STAs (e.g., STA21 and STA22). Instead of communicating directly with the OBSS STAs, AP1 may ask its associated STAs (e.g., STA11 and STA12) to to relay the CSI information. AP1 may transmit a Trigger frame to allocate one or more Peer-to-Peer (P2P) Triggered TXOP sharing Service Periods (SPs) to one or more associated STAs (STA11 and STA12). In general, the Triggered TXOP sharing SP may be a period within the TXOP acquired by the AP (using the Trigger frame) which may be used by STA11 and STA12 to perform peer-to-peer transmission(s), for example channel sounding relay procedures with other STAs including associated STAs and unassociated STAs. In the examples shown in FIG. 8, peer-to-peer MAP sounding report procedure with OBSS/unassociated STAs STA21 and STA22 is shown. This may be accomplished by STA11 and STA12 transmitting peer-to-peer BF Poll frames to STA21 and STA22, respectively. STA21 may generate sounding feedback based on the CSI measured between AP1 and STA21 in a previous sounding session. STA22 may generate sounding feedback based on the CSI measured between AP1 and STA22 in a previous sounding session. STA21 and STA22 may transmit the CSI to STA11 and STA12, respectively. Sharing AP1 may, at the end of the Triggered TXOP sharing SP, transmit a BFRP Trigger frame to solicit the aggregated feedback from its associated STAs, STA11 and STA12. In this manner, feedback from OBSS STAs STA21 and STA22 may be collected by sharing AP1.

In some embodiments, in the Trigger frame, or a special type of the Trigger frame, the sharing AP1 may include a User Info field with an AID field corresponding to an associated STA, e.g., STA11. The sharing AP1 may also allocate a time duration for the Triggered TXOP sharing SP. In some embodiments, one or more reserved bits in the Common Info field, Special User Info field, or User Info field of the Trigger frame may indicate the User Info field contains a time domain resource allocation. When the bit or bits are set, then the RU allocation subfield may indicate the duration of the Triggered TXOP sharing SP. Alternatively, or additionally, other subfields, such as an UL FEC Coding Type subfield, and/or UL MCS subfield, UL DCM subfield, and/or Reserved subfield, and/or UL Target Receive Power subfield and/or SS Allocation/RA-RU subfield, may be repurposed and used to indicate the duration of the TXOP sharing SP. In another embodiment, a combination of the above-mentioned subfields may be used to indicate the duration of the Triggered TXOP sharing SP.

In some embodiments, in the Trigger frame, the sharing AP1 may include more than one User Info fields with AIDs corresponding to its associated STAs, e.g., STA11 and STA12. The sharing AP1 may allocate multiple time slots to the STAs and each time slot may be assigned to one STA. In some embodiments, one or more reserved bits in the Common Info field, Special User Info field, or User Info field of the Trigger frame may indicate the User Info field may contain a time domain resource allocation. In some embodiments, each User Info field in the Trigger frame may indicate or carry a duration for a Triggered TXOP sharing SP. The first Trigger TXOP sharing SP may begin after a SIFS duration following the end of the Trigger frame. The STA corresponding to the k^{th} User info field may be allocated to use the k^{th} Triggered TXOP sharing SP. Each STA may need to decode all the User Info fields before its own User Info field to determine the starting time of its allocated SP. In some embodiments, each User Info field may carry a starting time and duration of the allocated Triggered TXOP sharing SP. In some embodiments, a common duration subfield may be carried in the Common Info field or Special User Info field. The common duration subfield may indicate the duration of each Triggered TXOP sharing SP. For example, all the Triggered TXOP sharing SPs may have the same duration. In this way, a STA may need to check the order of its own User Info field to determine the start time of its Triggered TXOP sharing SP.

In some embodiments, in the Trigger frame, the sharing AP1 may include more than one User Info field, each User Info filed including an AID corresponding to each of its associated STAs, e.g., STA11, STA12. The sharing AP1 may allocate time-frequency resources to the STAs. In some embodiments, the Trigger frame may indicate that the allocated Triggered TXOP sharing SPs are used for P2P CSI/CQI exchanges. In some embodiments, the Trigger frame may indicate the initiator and/or the responder of the Triggered TXOP sharing SP.

As shown in FIG. 8, a STA11 and/or STA12 may transmit a beamforming report poll (BFRP) frame or a BFRP trigger frame to request a CSI/CQI report from another STA (namely, STA21 and/or STA22). If more than one STA shares a Triggered TXOP sharing SP, the STAs may use the allocated time-frequency resources to perform their transmissions.

As shown in FIG. 8, after the Triggered TXOP sharing SPs, the sharing AP1 may regain ownership of the TXOP. The sharing AP1 then transmits a BFRP Trigger frame to trigger a CQI/CSI report from one or more STAs (namely STA11 and STA12), as described above.

In some embodiments, an aggregated beamforming report may be transmitted to the sharing AP1 in response to the BFRP Trigger frame that the sharing AP1 sends. The aggregated beamforming report may carry the CSI/CQI report between multiple pairs of transmitters and receivers. For example, as shown in Error! Reference source not found. FIG. 8, the report from STA11 may carry CSI information between AP1 and STA11 and CSI information between STA21 and AP1 (for example, information that STA11 obtained during Triggered TXOP sharing SP).

In some embodiments, an A-MPDU may be used to carry CSI information between multiple pairs of transmitters and receivers. With an A-MPDU format, MAC headers may be carried in each MPDU. For the MPDU that carries the channel between two STAs, some the address fields in the MAC header may be used to carry the MAC addresses of the two STAs. In some examples, each MPDU may be a HE Compressed Beamforming/CQI action frame that may carry CSI between a pair of transmitter and receiver, e.g., AP1 and STA11. Some address fields in the MAC header of the MPDU may contain MAC addresses of AP1 and STA11.

Referring to FIG. 9, an embodiment is shown where Error! Reference source not found. STA11 and STA12 share the Triggered TXOP sharing SP with different allocated frequency resources. Thus, STA11 and STA12 may transmit on the allocated resources to STA21 and STA22 respectively. STA21 and STA22 may respond with one or more CSI/CQI reports including measurements performed when AP1 transmitted an NDP sounding frame. In this example, AP1 may allocate the Triggered TXOP sharing SP with STA11 and STA12 by exchanging a Trigger frame and CTS frames. STA11 may generate a sounding report based on the CSI measured between AP2 and STA11 in a previous sounding session. STA12 may generate a sounding report based on the CSI measured between AP2 and STA12 in a previous sounding session. STA11 and STA12 may transmit their BF Report frames to STA21 and STA22 respectively with the prepared sounding reports. STA21 may generate a sounding report based on the CSI measured between AP1 and STA21 in a previous sounding session. STA22 may generate a sounding report based on the CSI measured between AP1 and STA22 in a previous sounding session. STA21 and STA22 may transmit their BF Report frames to STA11 and STA12, respectively, with the prepared sounding reports. After the Triggered TXOP sharing SPs, the sharing AP1 may regain ownership of the TXOP. The sharing AP1 then transmits a BFRP Trigger frame to trigger a CQI/CSI report from one or more STAs. In this example, on reception of the BFRP Trigger frame from AP1, STA11 and STA12 may transmit their aggregated CSI reports to AP1, and STA21 and STA22 may transmit their aggregated CSI reports to AP2. The transmissions may be multiplexed in time/frequency/spatial domain.

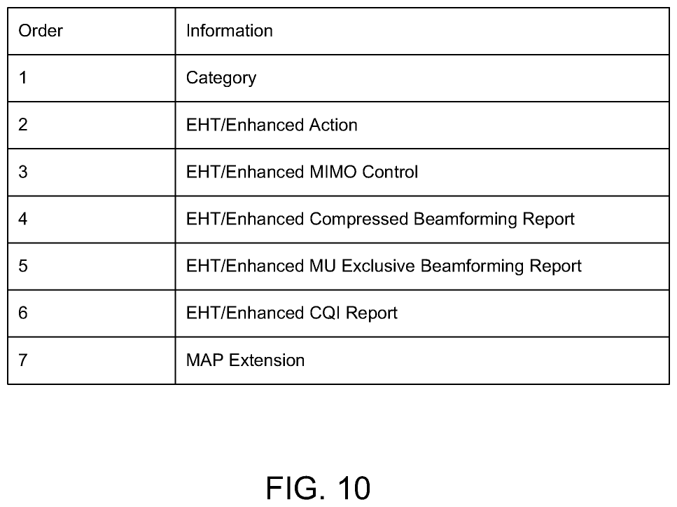

FIG. 10 provides an example of an EHT/Enhanced Compressed Beamforming/CQI frame Action field format. In some embodiments, a newly defined enhanced Compressed Beamforming/CQI Action frame exists as shown in Error! Reference source not found. FIG. 10. A MAP Extension field may be added to the Action frame. The MAP Extension field may carry MAP related information. For example, it may carry a beamformee/beamformer ID subfield with MAC addresses or compressed MAC addresses or another type of ID for the beamformee and beamformer the CSI/CQI is related to. The presence of the MAP Extension field and/or beamformee/beamformer ID subfield may be optional. In one of the mandatory fields such as the enhanced MIMO Control field, a bit may be used to indicate the presence of the MAP Extension field.

It is noted that the abovementioned procedures may be extended to a single BSS case, where all STAs are associated with a single AP. Some STAs may be at the edge of the BSS and they may use other STAs to relay the CSI/CQI information to the AP. It is further noted that the above-described SIFS between transmissions may be replaced with other inter-frame spacing. The Trigger frame design disclosed may be used in any case where a Triggered TXOP sharing SP may be used.

In other embodiments, CSI feedback may be solicited from OBSS STAs using BFRP Trigger frames using B25 of the EHT variant User Info field in a trigger frame. The EHT User Info field is shown in FIG. 6. Reserved bit 25 (i.e. B25) may be renamed to (in-BSS/OBSS) subfield and used to indicate that this User Info is intended for a STA that is associated with another AP in the coordinating group. For example, B25 may be set equal to 0 to indicate a STA is an in-BSS STA. B25 may be set equal to 1 to indicate the STA is an OBSS STA, or vice-versa. It should be noted that B25 may be just one example of a bit range that is used to carry the in-BSS/OBSS bit; however, bits in other locations may also be used for the same purpose.

In some embodiments, an indication may be carried in the Special User Info field and/or in the Common Info field of a trigger frame indicating whether the trigger frame is used to solicit transmissions by STAs associated with the sharing AP.

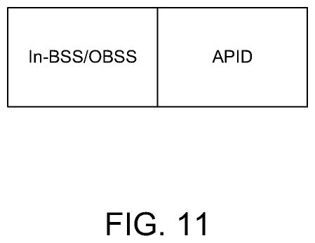

FIG. 11 illustrates an example of the Trigger Dependent User Info subfield in a BFRP Trigger frame. In some examples, the Trigger dependent User Info subfield of the BFRP Trigger frame indicates that associated User Info field is destined for a an in-BSS STA or an OBSS STA, as depicted in Error! Reference source not found. FIG. 11. In one embodiment, the first bit of the Trigger dependent User Info subfield may be named in-BSS/OBSS, where a value of 0 indicates in-BSS STA and a value of 1 indicates OBSS STA, or vice-versa. The remaining bits of the subfield may be used to signal the APID, which may be an ID associated with the AP that this STA is associated with. Examples of the APID may include the least significant 7 bits of the AID11 assigned to each AP in the Multi-AP coordinating group; the entire AID11 assigned to each AP in the Multi-AP coordinating group; a part of the compressed BSSID of the AP that the STA is associated with; or the entire compressed BSSID of the AP that this STA is associated with.

In some embodiments, reserved bits (for example, B37-B39 of the EHT Special User Info field shown in FIG. 7, described in paragraphs above) of the EHT Special User Info field may be used to signal the number of the STAs from OBSSs that are triggered in this trigger frame. In this embodiment, the User Info fields of the OBSS STAs may be located directly after the Special User Info field. In other words, the EHT Special User Info field is the first field after the Common Info field in a Trigger frame,

In some embodiments, the Trigger Dependent User Info subfield of the Special User Info field may be used to signal a map of the following User Info list indicating which STA or STAs are in-BSS STAs and which STA or STAs are OBSS STAs. The reserved bits in the Special User Info field (B37-B39) as shown in FIG. 7, described in the paragraphs above, may indicate the number of the Trigger Dependent User Info subfields in the Special User Info field. The order of the Trigger Dependent User Info subfields may indicate the mapping to the User Info subfields following the Special User Info field where each Trigger Dependent User Info subfield may map to a User Info subfield in the same order. Each Trigger Dependent User Info subfield may include a bit to indicate that this subfield is mapped to an in-BSS or OBSS STA, and the remaining bits may be used to include an APID.

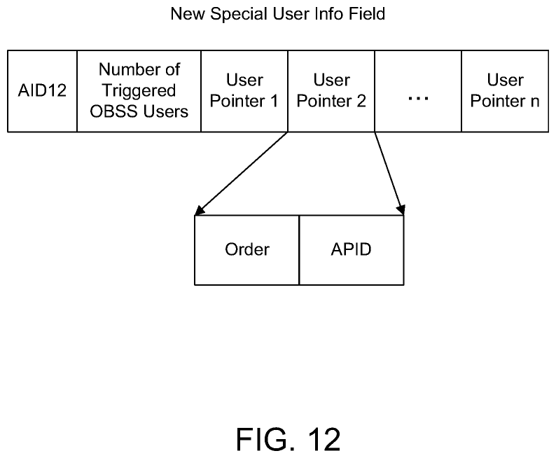

FIG. 12 illustrates a new Special User Info field format that may be included in a Trigger frame, as discussed above. This new Special User Info field may be placed, for example, just after the existing Special User Info field. The new Special User Info field may use another special ID to indicate that it is for Multi-AP triggering purposes. The subfields of the new Special User Info field may be defined as follows. AID12 may be set as a special ID. A Number of Triggered OBSS Users field may indicate how many OBSS Users are triggered in the present trigger frame. A plurality of User Pointer subfields then follow, where each User Pointer subfield may point to one of the User Info fields following the new Special User Info field. In some embodiments, a User Pointer subfield may include a subfield to explicitly indicate the order of this User Info field in the trigger frame. In some embodiments, the User Pointer subfield may have the same order of the User Info fields where all the User Info fields of an OBSS STAs may be located, for example, just after the new Special User Info field. In such cases, the order may be indicated implicitly. Also, the User Pointer subfield may include an APID associated with the OBSS STA.

In some embodiments, a Trigger frame, for example, a BFRP trigger frame, may be used to trigger feedback transmissions from STAs that are associated with another AP, such as an OBSS AP. For example, when a first member AP in a Multi-AP set wants to solicit sounding feedback from STAs that are associated with a second member AP, the soliciting AP (the first AP) may send a trigger frame, for example, a BFRP trigger frame, that includes a receiver address (RA) set to the BSSID of the second AP's BSS. The BFRP trigger frame may contain an indication that the BFRP trigger frame is targeted to the STAs that are associated with the second AP's BSS. For example, such an indication may be the group bit in the RA MAC address. Alternatively or additionally, the indication may be one or more bits contained in the trigger frame, such as one or more bits contained in the Common Info field of the trigger frame.

In some embodiments, the Trigger frame, for example, a BFRP trigger frame, may contain one or more new Special User Info fields. The new Special User Info field or User Info field may contain an ID or AID associated with an AP of the multi-AP set (MPS). A User Info field that follows the Special User Info field may contain an AID that represents a STA that is associated with that member AP. The AID of the STA used in the User Info field may be the AID that is assigned to the STA by member AP that the STA is associated with. Additional Special User Info fields or User Info fields may contain IDs or AIDs that each represent another member AP of the MPS. The User Info field that follows the Special User Info field or User Info field that represents a second member AP of the MPS may contain an ID or AID for a STA that is associated with the second member AP. The ID or AID may be the AID that is assigned to the STA by the second member AP.

In some embodiments, a Trigger frame, for example, a BFRP trigger frame, may be used by an AP to trigger feedback transmissions from STAs that are associated with one or more APs, such as one or more member APs that may belong to the same MPS. The RA address of the trigger frame may be set to a MAC Address that represents the MPS.

In some embodiments, the Trigger frame, for example, a BFRP trigger frame, may contain one or more Special User Info fields. The Special User Info field may contain an ID or AID that represents the MPS. The User Info field that follows the Special User Info field may contain an AID that represents one or more STAs that belong to the MPS.

In some embodiments, the Trigger frame, for example, a BFRP trigger frame may, use one or more random access RUs/MRUs to solicit feedback transmissions from the MPS or from a particular BSS that belongs to one member AP of the MPS.

A coordinating member AP of an MPS may announce one or more member APs that are included in the Multi-AP Set (MPS). The coordinating member AP may indicate that one or more member APs for which its associated STAs should receive sounding frames, calculate feedback, and respond to the Trigger frames or BFRP trigger frames to provide sounding feedback.

In addition, a member AP may announce one or more IDs or AIDs for each of its associated STAs to be used when the STA is solicited by a member AP in the same MPS by a trigger, for example, by a BFRP trigger frame.

A STA associated with a member AP that belongs to an MPS may respond to a trigger frame, for example, a BFRP trigger frame, that is transmitted by a member AP of the same MPS if one or more or a subset or a combination of the following conditions are satisfied. For example, the trigger frame or BFRP trigger frame may be transmitted by a member AP that belongs to the same MPS, that may have been announced by the AP that is associated with the STA. The Trigger frame or BFRP trigger frame may be transmitted with an RA address that represents the BSS, for example, the BSSID, to which the STA belongs, and/or the Trigger frame may contain an indication that the trigger frame is intended for the STAs belonging to the BSS.

The trigger frame or BFRP trigger frame may contain a new Special User Info field which may contain an ID or AID that represents the BSS to which the STA belongs or the AP with which the STA is associated. Another condition may be satisfied when the ID or AID contained in a User Info field matches the ID or AID belonging to the STA, that may be assigned by the member AP to the STA. The ID or AID may be assigned or indicated as the regular AID, or be assigned or indicated as the ID or AID that should be used when solicited by a trigger or BFRP trigger frame that are transmitted by a member AP of the MPS to which the AP that the STA is associated with AP belongs, or is addressed to the BSS, or following a new Special User Info field that contains an ID or AID that represent the BSS to which the STA belongs or the AP with which the STA is associated.

Another condition may be satisfied when the trigger frame or BFRP trigger frame may indicate random access RUs/MRUs when solicited by a trigger or BFRP frame that is transmitted by a member AP of the MPS to which the STA's associated AP belongs, or is addressed to the BSS, or following a Special User Info field that contains an ID or AID that represent the BSS to which the STA belongs or the AP with which the STA is associated.

The STA may respond with a feedback transmission to the trigger or BFRP trigger frame, such as a beamforming report, compressed beamforming report, CSI, MIMO feedback or other type of feedback frames using allocated RU/MRU as indicated in the trigger or BFRP trigger frame or using UORA mechanism and one or more of the assigned random access RUs/MRUs.

Optimizing channel feedback procedures is desirable. The solutions described in the following embodiments may at least address the issues discussed above. In a beamforming feedback frame, a STA may transmit a Measured Channel Bitmap field, which may indicate the CSI/CQI information on certain subchannels. The Measured Channel Bitmap field may be carried in an EHT/Enhanced compressed beamforming/CQI Action frame. In some embodiments, the EHT/Enhanced MIMO control field may carry the Measured Channel Bitmap field.

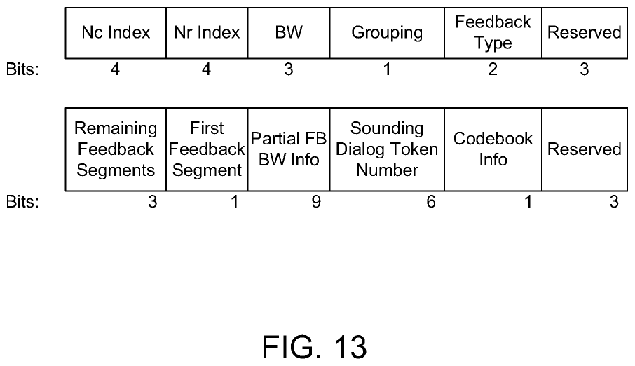

FIG. 13 illustrates an example of a modified EHT/Enhanced MIMO Control field. The EHT/Enhanced MIMO Control field may include a Nc Index field, a Nr Index field, a Bandwidth (BW) field, a Grouping field, a Feedback Type field, a first Reserved field, a Remaining Feedback Segments field, a First Feedback Segment field, a Partial FB BW Info field, a Sounding Dialog Token Number field, a Codebook Info field, and/or a second Reserved field. In some embodiments, a partial BW Info subfield may be used to carry the Measured Channel Bitmap field described above. In some embodiments, the subfield may be renamed as a Partial FB BW Info as shown in FIG. 13. In some embodiments, a number of bits (for example, 9 bits) may be used for this subfield. Bit 0 (B0) may indicate the resolution. For example, when the BW subfield is set to 0 to 3 (or BW is equal to or less than 160 MHz) then B0 may be set to 0, and the measured channel bitmap resolution is 20 MHz. The measured channel bitmap may have, e.g., 8 bits and each bit may indicate if the CSI/CQI on the corresponding 20 MHz subchannel is included in the report. When a BW subfield is set to 4 (or the BW is equal to 320 MHZ) then B0 may be set to 1, and the measured channel bitmap resolution may be 40 MHz. The measured channel bitmap may have 8 bits and each bit may indicate if the CSI/CQI on the corresponding 40 MHz subchannel is included in the report. In some methods, a number of bits, e.g., 8 bits, may be used for a measured channel bitmap and the resolution may be implicitly signaled by a BW subfield.

In other embodiments, a sounding procedure with the enhanced Partial FB BW Info field may be utilized. For example, a beamformer may transmit an NDPA frame to one or more beamformees to begin a sounding procedure. Then, a beamformee may detect the NDPA frame addressed to it and prepare the upcoming sounding. The beamformer may then transmit one or more NDP frames after the NDPA frame. The beamformer may transmit a BFRP Trigger frame to trigger the BF report from one or more beamformees.

In a case where the beamformee may experience relatively high interference on one or more subchannels where the sounding/NDP frame is sent, or the Beamformee may have a NAV setting on one or more subchannels, for example, the NDP frame may be transmitted on subchannel 1-4, and the beamformee may detect subchannel 3 may be busy, a solution is needed. The beamformee may include the Partial FB BW Info field in the Enhanced MIMO Control field in the compressed BF/CQI frame. The Partial FB BW Info field may indicate on which subchannel there is no BF/CQI report. In the above example, there is no BF/CQI report on subchannel 3 because the subchannel was determined to be busy based on the NAV setting.

In the compressed beamforming report field and/or MU exclusive beamforming report field and/or CQI report field, the reports related to the subchannels identified in the Partial FB BW Info field may not be included. In the example above, reports related to subchannel 3 may not be included.

In further embodiments, to resolve the problems mentioned above regarding different standard releases, one solution may be to set 1 bit, or a few bits in the reserved bits, for indication of the release or releases that the device is capable of supporting. Other reserved bits may be used for other purpose for Release 1, e.g., control the PAPR (Peak to Average Power Ratio) of the Signal field, or some R1 specific features (i.e., the features for R1 devices only). If those bits are used to control the PAPR of the transmit signal or other purposes, they may be different for different channel bandwidths and/or subchannel/preamble puncturing patterns, and/or MCSs, and/or Guard Internals.

In another embodiment, there are N reserved bits in total. One bit may be used to indicate whether the device is capable of operating in accordance with release 1, for example. If the bit is set to indicate release 1, the rest N−1 reserved bits may be used to indicate any sequence to reduce PAPR and receivers may ignore the N−1 reserved bits. If the bit is set to indicate release 2 or a later release version, the rest N−1 reserved bits may be used to indicate features of release 2 or later release version. In this case, release 1 receivers may ignore the N−1 reserved bits, but release 2 receivers may understand their meaning.

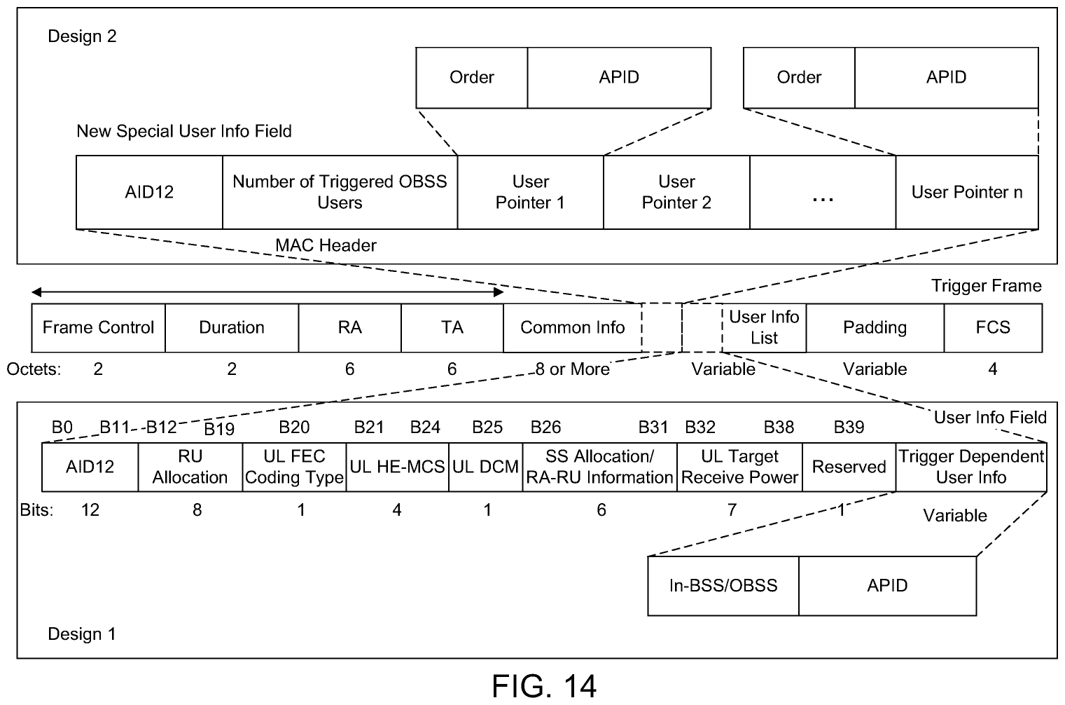

In summary, referring to FIG. 14, two embodiments are disclosed herein to support feedback from OBSS STAs in a multi-AP system. The Trigger frame shown in FIG. 14 is the same Trigger frame shown and described in FIG. 5. The Trigger frame may be a BFRP trigger frame. In some embodiments described above, generally calling them “Design 1”, a User Info field as described above with reference to FIG. 6 is present after the Common Info field of the Trigger frame. The User Info field includes, in a variable length Trigger Dependent User Info field described with reference to FIG. 11, an indication of whether the STA addressed in this User Info field is associated to an in-BSS or to an OBSS, and an APID to identify the AP to which the STA addressed in this User Info field is associated. A STA that has a matching AID of the User Info field and the APID of its associated AP matches the APID in the Trigger Dependent User Info field, may generate feedback and transmit the feedback to the AP which sent the trigger frame. In “Design 2”, a New Special User Info field, as described above in connection with FIG. 12, is present after the Common Info field of the Trigger frame. The New Special User Info field includes one or more User Pointer fields, one User Pointer field for each User Info field that is present in the Trigger frame. Each User Pointer field includes an order field to indicate the order of the User Info field in the User Info list and an APID field. A STA that has a corresponding APID in the Special User Info field may look for the User Info field in the User Info list at the order specified by the Order subfield. If the STA AID matches the AID in the User Info field, the STA may generate feedback and transmit the feedback to the AP which sent the trigger frame. In both of these designs, a STA maybe directed to transmit feedback to an AP that the STA is not associated with.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Although the solutions described herein consider 802.11 specific protocols, it is understood that the solutions described herein are not restricted to this scenario and are applicable to other wireless systems as well. Although an SIFS may be used to indicate various inter frame spacing in the examples of the designs and procedures, all other inter frame spacing such as RIFS, AIFS, DIFS or other time intervals could be applied in the same solutions. Although four RBs per triggered TXOP are shown in some figures as examples, the actual number of RBs/channels and the bandwidth utilized may vary. Although specific bits may be used to signal in-BSS/OBSS, for example, other bits may be used to signal this information.

1. A station (STA) associated with a first access point (AP) that is a member of a multi-AP set, the STA comprising:
a transceiver configured to receive a trigger frame from a second AP that is also a member of the multi-AP set, wherein the STA is not associated with the second AP, the trigger frame including an association identifier (AID) relating to the association between the STA and the first AP, and an AP identifier (APID) of the first AP; and
the transceiver further configured to transmit a feedback message, to the second AP, including information indicative of a channel quality of a communication channel between the STA and the second AP.

2. The STA of claim 1, further comprising:
a processor configured to determine that the AID included in the trigger frame corresponds to a stored AID relating to the association between the STA and the first AP, to determine that the APID included in the trigger frame corresponds to an APID of the first AP, and to generate the feedback message.

3. The STA of claim 2, wherein the feedback message is a beamforming report.

4. The STA of claim 2, wherein the feedback message includes channel quality information (CQI).

5. The STA of claim 1, wherein the second AP is associated with an overlapping basic service set (OBSS) AP.

6. The STA of claim 1, wherein the trigger frame is a beamforming report poll (BFRP) trigger frame.

7. The STA of claim 6, wherein the trigger frame includes a User Info field that includes the AID, and the User Info field includes a Trigger Dependent User Info field that includes an overlapping basic service set (OBSS) indicator and the APID of the first AP.

8. The STA of claim 7, wherein the OBSS indicator indicates that the APID is associated with an OBSS AP.

9. The STA of claim 6, wherein the trigger frame includes a New Special User Info field including a User Pointer field associated with a corresponding User Info field, wherein the User Pointer field includes the APID, and the corresponding User Info field includes the AID.

10. A method for use in a station (STA) associated with a first access point (AP) that is a member of a multi-AP set, the method comprising:
receiving a trigger frame from a second AP that is also a member of the multi-AP set, wherein the STA is not associated with the second AP, the trigger frame including an association identifier (AID) relating to the association between the STA and the first AP, and an AP identifier (APID) of the first AP; and
transmitting a feedback message, to the second AP, including information indicative of a channel quality of a communication channel between the STA and the second AP.

11. The method of claim 10, further comprising;
determining that the AID included in the trigger frame corresponds to a stored AID relating to the association between the STA and the first AP;
determining that the APID included in the trigger frame corresponds to an APID of the first AP; and
generating the feedback message.

12. The STA method of claim 11, wherein the feedback message is a beamforming report.

13. The STA method of claim 11, wherein the feedback message includes channel quality information (CQI).

14. The STA method of claim 10, wherein the second AP is associated with an overlapping basic service set (OBSS) AP.

15. The STA method of claim 10, wherein the trigger frame is a beamforming report poll (BFRP) trigger frame.

16. The STA method of claim 15, wherein the trigger frame includes a User Info field that includes the AID, and the User Info field includes a Trigger Dependent User Info field that includes an overlapping basic service set (OBSS) indicator and the APID of the first AP.

17. The STA method of claim 16, wherein the OBSS indicator indicates that the APID is associated with an OBSS AP.

18. The STA method of claim 15, wherein the trigger frame includes a New Special User Info field including a User Pointer field associated with a corresponding User Info field, wherein the User Pointer field includes the APID, and the corresponding User Info field includes the AID.
